(19) United States
(12) Patent Application Publication
(10) Pub. No.: US 2011/0258005 A1
(43) Pub. Date: Oct. 20, 2011

(54) SYSTEM AND METHOD FOR ANCILLARY TRAVEL VENDOR FEE EXPENSE MANAGEMENT

(76) Inventors: Michael Fredericks, Fairfax, VA (US); Ellen Trotochaud, Vernon Hills, IL (US); Sarah Kuberry, Seattle, WA (US); Joyce Clippinger, Woodinville, WA (US); Valery Gorodnichev, Vernon Hills, IL (US); Scott Johnson, Bothell, WA (US); Leonard Tong, Redmond, WA (US); Sanjay Almeida, Bellevue, WA (US); Anil Bhagwat, Redmond, WA (US); Paul Parter, Bellevue, WA (US); John Love, Woodinville, WA (US)

(21) Appl. No.: 12/773,282

(22) Filed: May 4, 2010

Related U.S. Application Data
(60) Provisional application No. 61/324,533, filed on Apr. 15, 2010.

(51) Int. Cl. G06Q 10/00

(52) U.S. Cl. 705/5

(57) ABSTRACT

A computer-implemented method and system for ancillary travel vendor fee expense management comprising: receiving, by at least one expense management application, travel expense transaction data, said travel expense transaction data further comprising at least one expense transaction attribute; generating, by the at least one expense management application, at least one travel expense transaction record, wherein said at least one travel expense transaction record includes said expense transaction data, and storing said at least one expense transaction record in an expense transaction database; determining, by at least one ancillary fee module which analyzes the at least one expense transaction attribute, whether the at least one expense transaction corresponds to a travel event, a fee for an ancillary good or service offered by a travel vendor, or a fee for an ancillary good or service offered by a travel agency; presenting the at least one expense transaction record on a computerized user interface contained within at least one expense management application, wherein it is indicated whether the at least one expense transaction is at least one ancillary fee; and, adding the at least one expense transaction record to an expense report.

This application is based on and derives the benefit of the filing date of U.S. Provisional Patent Application No. 61/324,533, filed Apr. 15, 2010. The entire content of this application is herein incorporated by reference in its entirety. In addition, this application incorporates by reference U.S. patent application Ser. No. 10/373,096, entitled “System and Method for Integrating Travel and Expense Management”, filed on Feb. 26, 2003.

### BRIEF DESCRIPTION OF THE FIGURES

FIG. 1 illustrates the primary components of a representative operating environment, according to an embodiment of the present invention.

FIG. 2 is a system diagram illustrating an expense management application, according to one embodiment of the present invention.

FIGS. 3 and 4 are flowcharts illustrating a matching scenario, according to an embodiment of the present invention.

FIG. 5 is a flowchart illustrating matching of travel data and expense data, as performed in FIG. 3, according to an embodiment of the present invention.

FIGS. 6 through 11 are screen shots illustrating a typical scenario experienced by a user, according to one embodiment of the present invention.

### BACKGROUND OF THE DISCLOSURE

Many entities (e.g., companies, governments, charities) compete on cost. These entities can increase their revenue by allowing customers to purchase additional goods or services at or before the time of consuming at least one primary good or service offered. The example of an airline is discussed in this specification. However, those of ordinary skill in the art will see that the concepts could be applied to other entities, both within the larger travel industry (e.g., air travel, hotel, rental car, rail) and across other industries.

For example, airlines have a business with extremely large fixed costs (e.g., aircraft costs, labor costs) and relatively small variable costs (e.g., fuel costs, drink costs). Airlines often compete on price. Airlines can add ancillary fees above and beyond the primary service offered, which is the basic ticket. These ancillary fees can include, but are not limited to: fees for advanced seating, fees for preferential seating (e.g., seats with more leg room, exit row seats, or aisle/window seats), fees for earning frequent flier miles, fees for blankets and pillows, fees for on-board concessions (e.g., food and beverage), fees for in-flight internet access, fees for checking bags, fees for carrying on bags and storing them in the overhead compartments above the seats, and even fees for using the lavatories.

From a marketing standpoint, the airlines can also find the fees attractive because the concept allows each passenger to determine the specific service level desired. If a traveler wishes to save money, the traveler could choose not to earn frequent flier miles, sit in a middle seat, not check a bag, and choose not to avail herself of the on-board dining options. A traveler who wished to travel in more comfort could elect to pay for all of these things. The two travelers may pay widely different rates for seats next to each other on the same plane, and both may be happy with the value received per dollar spent.

In addition, markets can change frequently. Airlines and other vendors can change ancillary fees quite frequently, which can make it difficult to track the costs of ancillary fees. Ancillary fees can pose additional challenges to entities managing their costs. These challenges are described in more detail below.

Typically, any expenses incurred by the traveler while traveling at the request of his employer are reimbursed by the corporation. Companies have travelers (or other users, such as assistants, accountants, etc.) complete expense reports that itemize the expenses, and have the expense reports approved by managers and/or employees in the accounting department. Systems that automate some or all of the expense reporting process can accept data feeds from corporate credit card vendors (e.g. Visa, American Express, MasterCard) and can allow the travelers to import the credit card charges to reduce manual data entry and improve accuracy. Expense management systems can also be integrated with travel agency systems, or global distribution systems (GDS) (e.g., Apollo, Sabre, or Amadeus), to obtain, for example, travel itinerary data. The travel itinerary data can be matched with credit card data (using, for example, vendor information, amounts, dates of travel, etc.). Companies can then run reports on their travel and expense data to look at the total spent by type of transaction (e.g. air fare, rental car, meals, entertainment) or the total spent by supplier (e.g. United Airlines vs. American Airlines). More sophisticated systems can compare the amounts requested for reimbursement against the amount of a reservation to see if the actual cost differed from the initially requested cost, analyze the vendor spend for specific geographic regions or airline city pairs, and import receipts directly from vendors in order to have a third source for matching against the travel itinerary and credit card data.

Travel managers can use the reservation and expense data when negotiating with airlines. For example, if a travel manager knows that her company is spending $1 million per year flying travelers from Washington, D.C. to Los Angeles, Calif., and that the amount is evenly split between two competing airlines, that travel manager could approach the airlines and offer to shift business from one to the other in exchange for some form of discount. Additionally, travel managers can set policies in systems that enable travelers to make travel reservations and systems that automate the completion of expense reports to indicate that certain expenses would not be reimbursed, or would need extra approval prior to reimbursement. For example, many companies do not reimburse for movies rented during hotel stays, or for airline club memberships (e.g. United Airlines Red Carpet Club) except under certain circumstances such as trips over a certain number of days or trips over a certain distance, or for certain very frequent travelers.

In the above situations, as well as in many other situations, ancillary fees can pose a challenge. For example, some ancillary fees can be charged at the time of the main purchase (e.g., at the time a ticket is purchased), while other ancillary fees are charged a check-in process or on-board. A traveler may not know at time of ticket purchase that a bag would be checked, or that the traveler would want a pillow on board. These ancillary fees can thus be charged to the traveler (e.g., via credit card) at a different time than the airline ticket itself. Thus, an entity would not always know what is being spent on these ancillary fees as opposed to the air fares themselves.

### DESCRIPTION OF EMBODIMENTS OF THE INVENTION

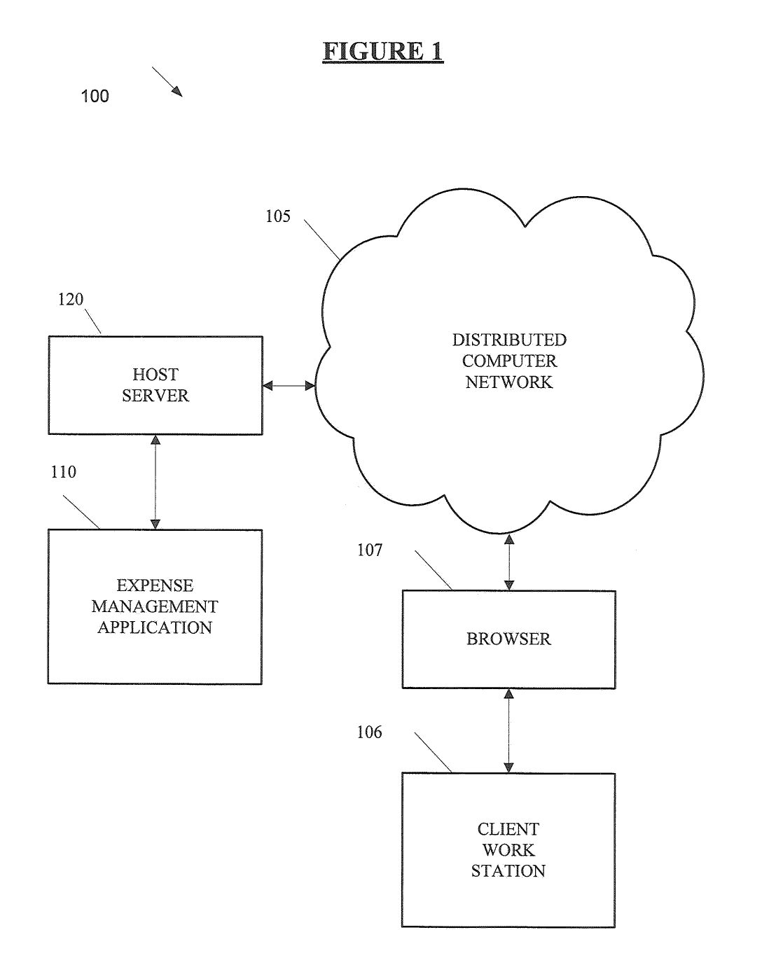

FIG. 1 illustrates a system for ancillary fee expense management. In one embodiment, a system and method are provided that can properly categorize ancillary fees as such, and can identify the specific reservation that corresponded to the main purchase (e.g., flight taken with airline ticket) on which the ancillary fee was incurred. In one embodiment, the system can enforce entity policies on the ancillary services. In one embodiment, reports can be provided that hold employees responsible for travel and accounting information about the spend, including the amount of spend by travel supplier and even the amount of spend in specific geographies, on certain routes, and/or by specific travelers or departments. This data can help the company negotiate these ancillary services as part of a contract with a specific travel vendor in lieu of or in addition to a specific rate on the base service. For example, a travel manager might prefer to negotiate free checked baggage instead of a 2% discount on the air fare, if it could be determined that the company was spending more than 2% of their air-related spend on checked baggage.

Additionally, outside booking agencies (e.g., travel agencies) can levy their own fees. For example, a service charge for completing a travel reservation can be levied. The outside agency may choose to offer ancillary goods or services of their own and charge fees for them. The fees charged by the outside agencies need to be distinguished from the fees charged by the entities (e.g., travel vendors) themselves.

FIG. 1 illustrates some primary components of a representative operating environment, according to an embodiment of the present invention. An on-line environment 100 can comprise: at least one distributed computer network 105; at least one client workstation 106; at least one browser 107; and at least one expense management application 110 in communication with at least one host server 120. It should be noted that many configurations are possible. For example, the expense management application 110 can be accessed from the work stations 106, which communicates with the host server 120. In addition, the expense management application 110 can be wholly or partially located on the client work station 106. Additionally, the expense management application 110 can be wholly or partially located on the host server 120. Those of ordinary skill in the art will see that other configurations are also possible.

Referring back to FIG. 1, the distributed computer network 105 can be a network (e.g., Internet, Intranet) that facilitates communication between one or more workstations 106, such as personal computers (PCs), minicomputers, microcomputers, main frame computers, telephone devices, or other wired or wireless devices, such as hand-held devices. and an expense management application 110, which is housed, for example, on a host server 120, which includes, for example, a minicomputer, a microcomputer, a PC, a mainframe computer, or other device with a processor and repository (e.g., database) or coupling to a repository.

The workstation 106 can accept input from users, and allow users to view output from the reporting application. The browser 107 can include software on the workstation 106 that let a user view, for example, HyperText Markup Language (HTML) documents and access files and software related to those documents. The present invention can utilize, for example, HTML-based systems, Java-based systems, XML-based systems and systems where a custom-built application communicates over the network. Those of ordinary skill in the art will see that many other types of systems can be utilized.

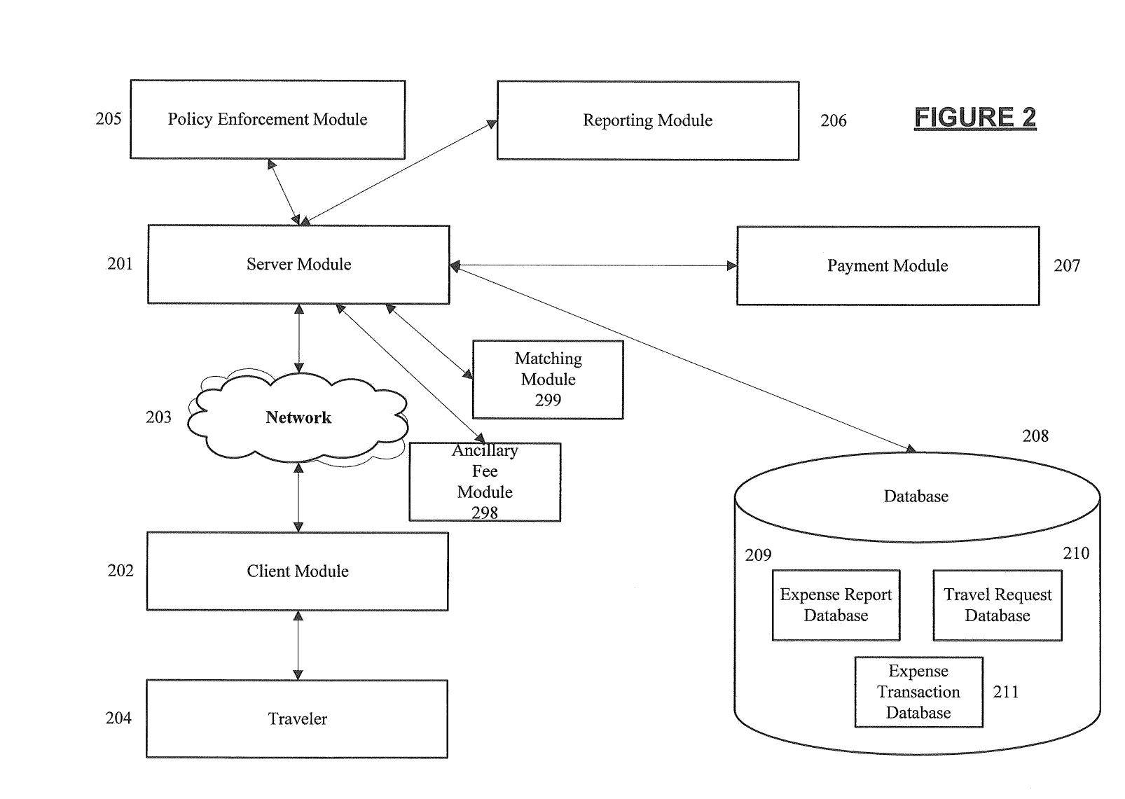

The expense management application 110 can work on or with a browser to display information to the user. The details of the expense management application 110 are set out in FIG. 2.

FIG. 2 is a system diagram illustrating expense management application 110 of FIG. 1, according to one embodiment of the present invention. While various modules are explained with respect to the expense management application 110, those of ordinary skill in the art will see that not all modules described are necessary. In addition, additional modules or combination modules are possible. Additionally, pieces of modules can be utilized. In one embodiment, the expense management application 110 can include a server module 201 and a client module 202 connected by a network 105. A traveler 204 can use the client module 202 to create and submit expense reports. In this embodiment, the client module 202 can be connected to the server module 201 to submit expense reports or download travel data or credit card data. The server module 201 can transmit data to the client (e.g., corporate policy data, data accumulated from various travel and expense data sources). Those experienced in the art will recognize that many other models can be used to build the expense management application 110. Those experienced in the art will also understand that while an expense report is in-progress, the data for the expense report can be stored on the client module 202, the server module 201, or both modules. Likewise, when the server module 201 transmits travel and expense data to the client module, the server module 201 can annotate that data with extra information not received from the original data sources. For example, the server module 201 may determine or receive an indication that charges from a certain vendor are of a certain type based on either domain information (e.g., charges from “Hilton” are typically hotel room charges) or information gleaned from previous uses of the system (e.g., a particular traveler has previously submitted charges from “Macaroni Grill” that were meals, so future charges from “Macaroni Grill” will likely be for meals). When an expense report is submitted, the data for the expense report can be sent to the server module 201. The expense report can be comprised of individual expense items, and each item can be matched to zero or more travel event requests or zero or more expense transactions.

The expense management can store the expense report in a repository 208. In one embodiment, the repository can comprise an expense report database 209, a travel request database 210, and an expense transaction database 211. The system can use these three databases 209, 210, and 211 to track which travel event requests and which expense transactions match a given expense item. The server module 201 can optionally then transmit the data to a policy enforcement module 205, a reporting module 206, or a payment module 207. Those experienced in the art will recognize that expense management application 110 can contain any number of modules that receive expense data.

The travel request database 210 can comprise data received by using some combination of multiple sources (e.g., an on-line booking tool, a travel agent, contact with a travel vendor). The travel request data from these sources is assembled and stored in the travel request database 210, typically as a Passenger Name Record (PNR).

The expense transaction database 211 can comprise expense data received from multiple sources. The payer (e.g., the traveler), pays the travel agency or travel vendor with, for example, a credit card. The record of this transaction can go to the credit card vendor, which can transmit funds to the travel vendor for the amount purchased.

The expense management application 110 can receive travel data from a travel system, expense transaction data from a credit card vendor, and purchasing data from a travel vendor. For a given expense, data may be present from any number of sources, including the possibility that no data is present. The expense management application 110 can receive data from different sources at different times and different rates. A source could transmit data continuously or near-continuously (e.g., once per hour), daily, weekly, or even monthly or at longer intervals. The expense management application 110 can store all the data received from all the sources when the information is received. The expense management application 110 can identify the traveler corresponding to a given travel request or expense data. Expense data can come encoded with a credit card number that has been assigned to a specific person. For central billed cards, other traveler-identifying information can be included. In an alternate embodiment, if a traveler uses an on-line self-booking tool to make a travel request, an identification of the user making the request (or user on whose behalf the request is made) can be stored at the time of request, and the record locator from the PNR can also be stored. Travel data identified by this specific record locator can be mapped to a specific traveler. Information about a traveler can be embedded into the remarks section of the PNR by the travel agency, or the passenger's name can be read from the PNR. Similar methods can be used to identify the traveler on data transmitted directly from a travel vendor. Additionally other uniquely identifying information, such as frequent traveler numbers, can be used.

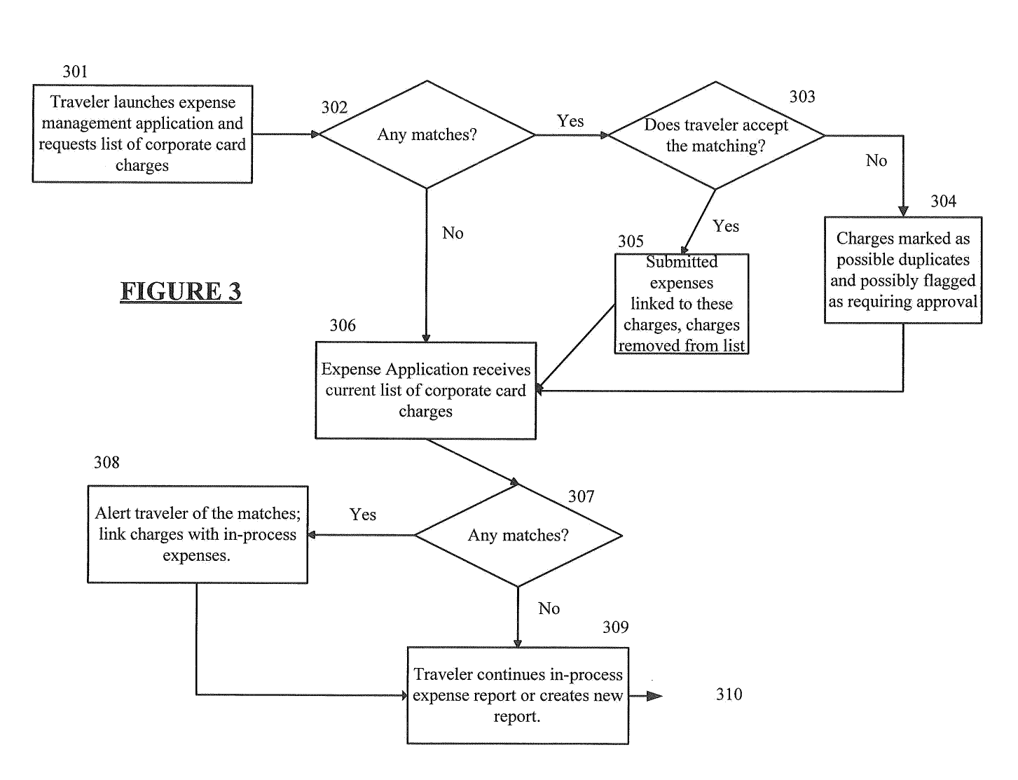

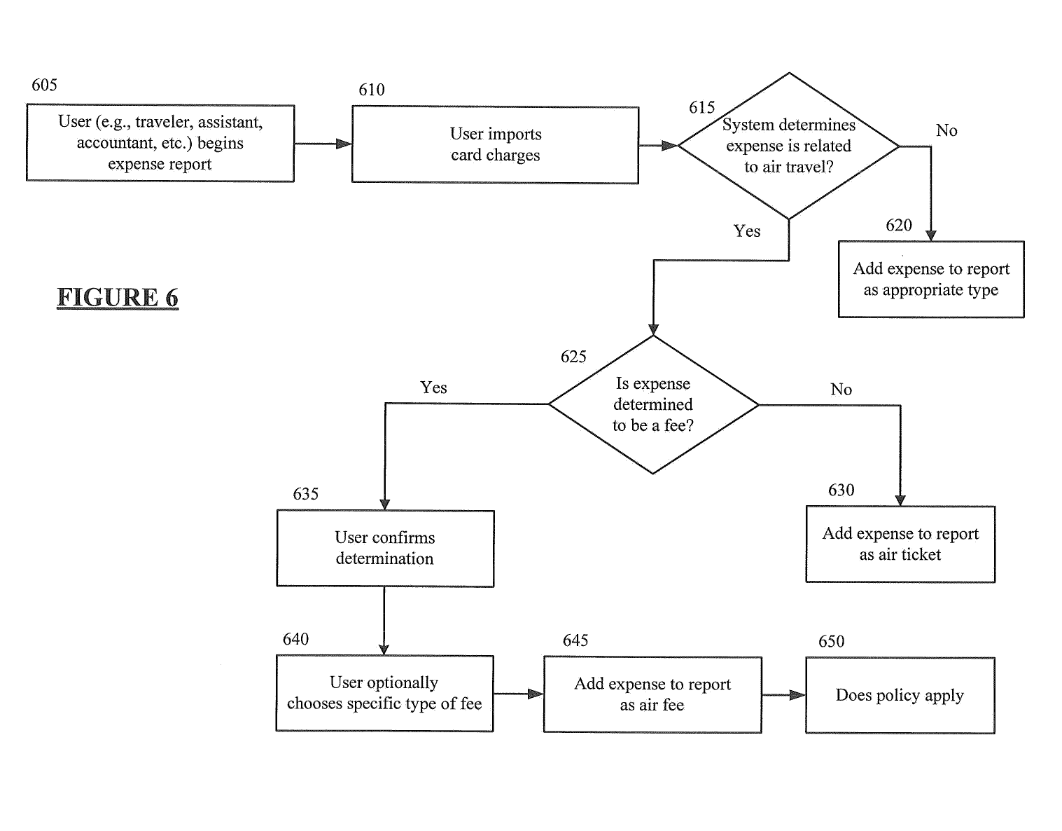

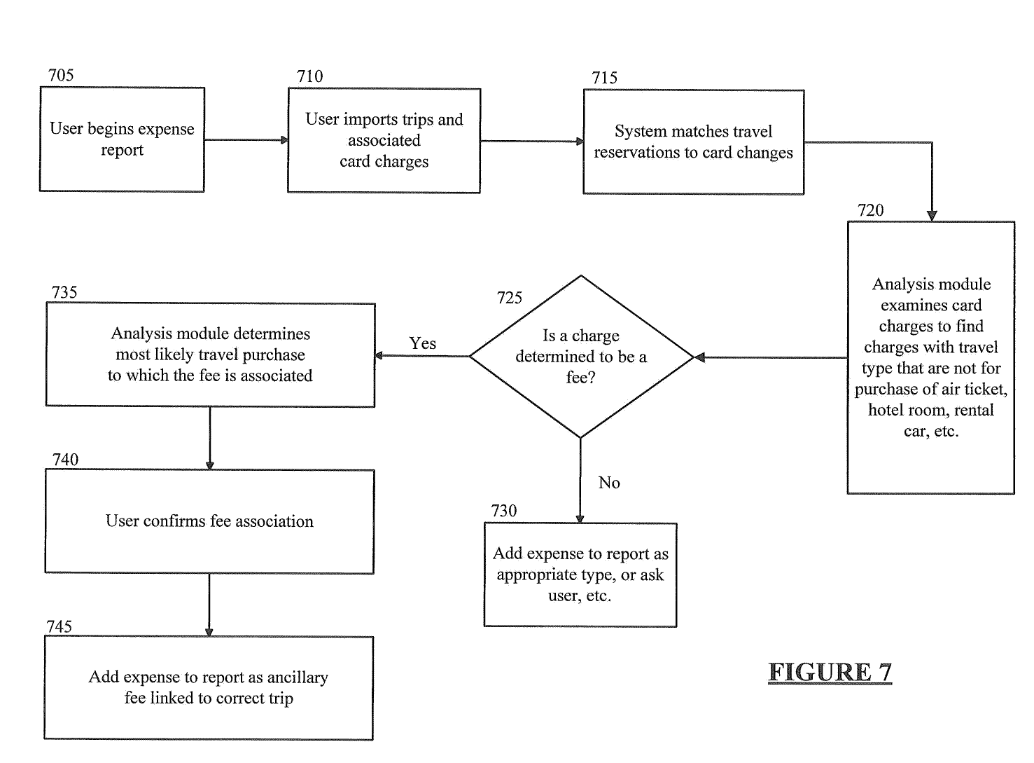

In some embodiments, the expense management application 110 can include a matching module 299 and an ancillary fee module 298. Features of the matching module 299 are explained below with respect to FIGS. 3-5. Features of the ancillary fee module 298 are explained below with respect to FIGS. 6-7.

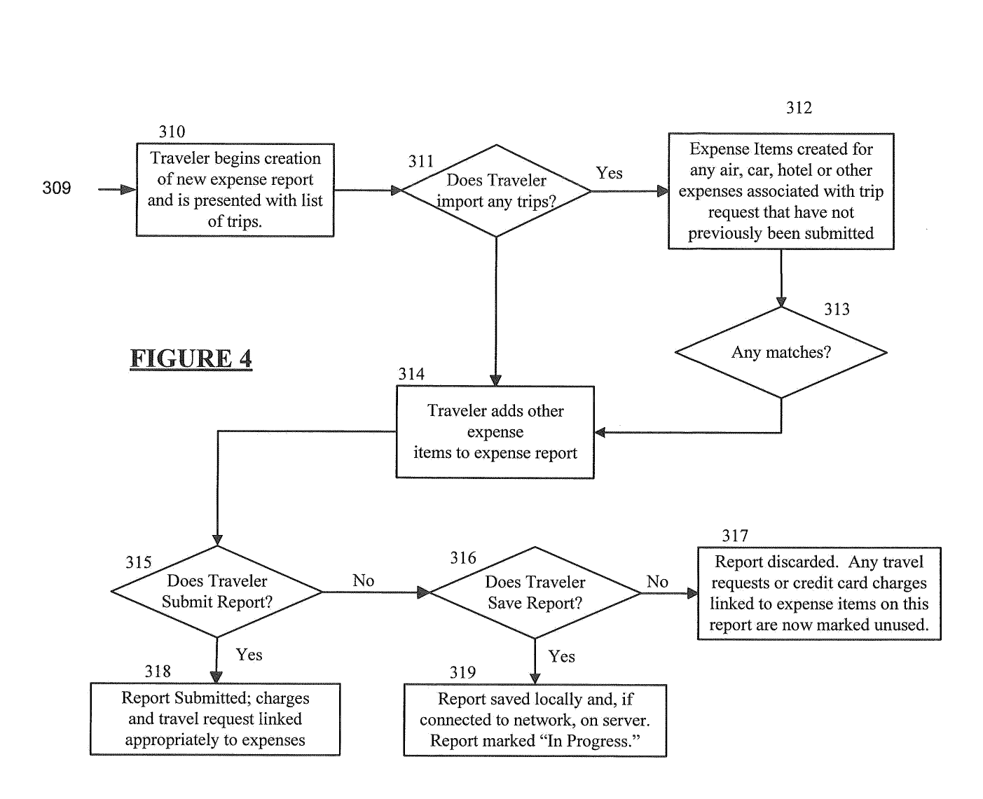

FIGS. 3 and 4 present a flowchart illustrating a matching scenario, according to one embodiment of the present invention. In 301, the traveler can begin a session in the expense management application 110. At application launch, if the computer running the application is connected to a network 105, a request can be transmitted to retrieve any new credit card charges that have been received since the last such request by this traveler. In 302, the expense management application 110 can determine whether there are any matches. The expense management application 110 can do this by comparing the list of new credit card charges to expenses on reports already submitted by this traveler. If no matches are found, the process can continue to 306. If yes, some charges match previously submitted expenses, the traveler can be notified in 303 and given the choice of accepting the matches or proceeding without matching. If no, the traveler does not elect to accept the matches, in 304 the charges that the system determined to be matches can be marked as possible duplicate expenses. Depending on company policy, any future expense report that contains one or more of these charges could require additional approval, for example, in order to help ensure expenses aren't reimbursed more than once. If yes, the traveler elected to accept the matches, in 305 the previously submitted expenses can be linked to these matched charges, and the matched charges can be removed from the list of newly available credit card charges that are transmitted to the client.

In 306, the expense management application 110 can receive the list of new charges from the server module 201. In 307, these charges can be compared to any expense reports that are currently in-progress to determine if any new charges match in-progress expenses. If no matches occurred, the process can proceed to 309. If yes, some charges match in-process expenses, the traveler can be notified in 308, and the user can proceed to 309. In 309, the system can determine whether an in-process expense reports is used, or a new expense report is created.

If an in-process report is used, the process can proceed to 314. If a new expense report is created, the process can proceed to 310, where the traveler can begin creation of a new expense report. In 311, the traveler can be presented with a list of trips available for import. If the expense management application 110 is currently connected to the expense management server module 201 by network 105, then the list of trips can be refreshed from the server module 201, otherwise the list is current as of the last time the application requested the list of trips from the server module 201. If the traveler chooses to import one or more trips then, in 312, expense items can be added to the expense report corresponding to any air, car, hotel, train, limousine, parking, taxi, or other items on the travel request for this trip. In 313, the current list of credit card charges can be compared to each newly created expense item. As in 311, if the expense management application 110 is currently connected to the expense management server module 201 by network 105, then the list of credit card charges may optionally be downloaded from the server module 201. Otherwise, the list of charges is current as of the last time the application requested the list of credit card charges from the server module 201.

In 314, the traveler can optionally add other expense items to the expense report. These items can be added manually or by adding other credit card charges as expenses. Although it is not shown in the flowchart, the traveler has the option in 314 of adding additional trips to the existing report by returning to 311. When the traveler is ready to end the session in 315, the traveler can elect to submit the expense report. This may require a network connection to the expense management application 110. If such network connection is not present then this option is not presented to the traveler. If the traveler elects to submit the expense report, then in 318, the new expense report can be transmitted to the expense management application 110 as a submitted report. Depending on company policy, various compliance checks can be run and these optionally may return the report to the traveler as not able to be submitted in which case the traveler can return to 314, where corrections can be made. If the server module 201 accepts the report, then applicable expense items can be linked to credit card charges and/or travel event requests. If the traveler does not wish to submit the report then the traveler can elect to save the expense report or discard it. If the report is saved, then in 319 the data can be saved to the local computer and, if there is a network connection to the expense management application 110, a copy can be saved there and marked as “in-progress.” This can allow the user to change computers in the future and still continue work on in-progress reports. If the user elects neither to submit nor save the report, then the report can be discarded in 317. Any credit card charges or travel event requests that were linked to items on this report can be marked as unused and can be available for import into future expense reports.

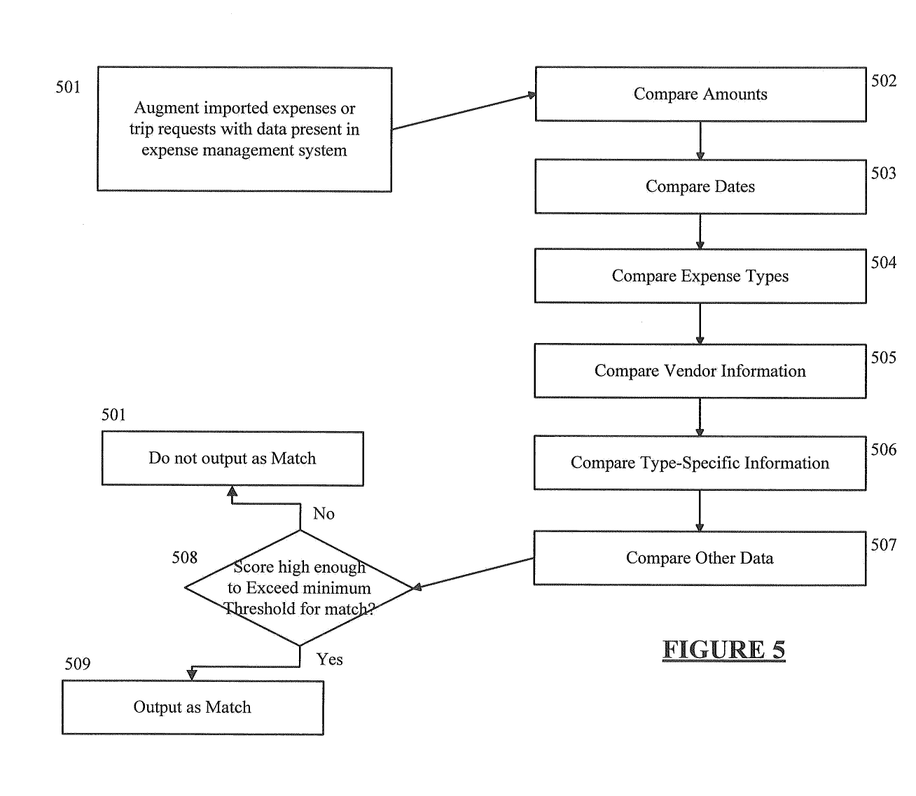

FIG. 5 is a flowchart illustrating matching of travel data and expense data, as performed in steps 302, 307, and 331 of FIGS. 3 and 4, according to an embodiment of the present invention. This matching can be done by a matching module 299, and, as with all other modules of the expense management application 110, can occur on the server 120 or the workstation 106, or both, or neither, depending on the embodiment of the expense management application 110 and the specific circumstance. The matching can processes the travel and expense data and attempt to identify travel event requests that match expense transactions. The matching subsystem can use a matching program to identify the likelihood of an expense transaction matching a travel event request. If the most likely match is above a threshold, then the request can be deemed to match the given expense transaction. One embodiment of a matching program can assign a numerical score to each combination of travel event request and expense transaction. For example, a match where both the travel event request and the expense transaction have the same vendor and the same rate for the same travel dates can score very highly. As another example, a match where the vendor matched, the dates were overlapping but not identical, and the amount was close but not exact can receive a lower score. Exact matches on different attributes can receive different scores, close matches can receive lower scores, and mismatches can receive even lower scores, no score or a negative score.

The matching module 299 can then output the matches, and output travel event requests and expense transactions that were not deemed to be matches but had scores that were close to the highest score or scores above a threshold. These non-matches could be used, for example, to present alternatives to the traveler if the traveler claims that the match outputted by the matching subsystem was not accurate. Those skilled in the art will recognize that there are virtually a limitless number of potential methods for matching information using various attributes of the expense transaction data, travel request data, other domain information, and past history of this or other travelers.

In some embodiments, expenses can come from a travel event request or a credit card charge or a vendor receipt, or any combination thereof. However the matching module 299 could also be used to match, for example, a credit card charge to an expense item that was manually keyed in by a traveler, so long as sufficient data has been provided by the traveler. For the purposes of this discussion, it will be assumed that a travel event request is being matched to a credit card charge, although a practitioner of the art would recognize that the term “travel event request” could be replaced with “expense one” and “credit card charge” could be replaced with “any other expense to make this discussion more general.

In 501, the raw data from the travel request and the credit card charges can be augmented with information from or by the expense management application 110. This extra information can be typically derived from knowledge about the traveler or about the traveler's past expenses. In some embodiments, this information can be readily obtainable inside the expense management application 110, but not available to or not present in the data from the providers of the travel and credit card feeds. For example, a credit card feed may not contain expense type information (e.g., it may not distinguish between air, car, hotel, or other charges). This can be the case when importing credit card charges from a personal card but this can occur on some corporate card imports as well. For example, as discussed below, if a charge comes in with a description of “United Airlines”, the expense management application 110 can look at past expenses and see that previously when expenses have been submitted and linked to credit card charges with a description of “United Airlines,” that expense has been an airfare expense. The expense management application 110 can then deduce that there is a high likelihood of this expense also being an airfare expense.

502 through 508 involve comparisons of the travel event request in this example to all available credit card charges each in turn. Depending on the results of any given comparison, the matching between the travel event request and a specific credit card charge can receive an increase or decrease or no change in score. In 509, the matching between travel event request and credit card charge with the highest score can be compared to a threshold. If the score is above the threshold, then the travel event request can be deemed to match the credit card charge in 510, and that information can used by the expense management application 110. If the score is not above the threshold, then the travel event request can be deemed to have no matches in 511 and that information is used by the expense management application 110.

In 502, the amounts on the travel event request and the credit card charge can be compared. If the amounts match exactly then one score can be given. If the amounts are close e.g., (within a defined threshold either percentage or constant amount), then a lesser score can be given, and if they are not close, then a still lesser score can be given.

In 503, the dates on the travel event request and the credit card charge can be compared. On some travel event requests there are multiple dates (e.g., the date of the reservation and/or the dates of travel). Likewise on some credit card charges there are multiple dates (e.g., the date the expense was incurred and the dates of travel). Whatever dates are available are used in this computation. For scoring purposes, exact matches can get the highest score. If the travel dates on one are wholly included in the travel dates on the other, a lesser score can be given. An example of this would be a travel request stating a hotel was to reserved the 11.sup.th through the 13.sup.th of the month, but the credit card charge states that it covers a hotel reservation from the 11.sup.th through the 12.sup.th (the traveler left one day early). If the travel dates overlap but are not wholly included then a still lesser score can be given. If the travel dates do not overlap but are close or the expense dates do not match but are close (within a threshold), then a still lesser score can be given, and if the travel dates do not match at all then a still lesser score can be given. Practitioners of the art would realize that different embodiments could assign the same scores to categories where this embodiment chooses to assign a lesser score (for example wholly included travel dates could score the same as overlapping travel dates).

In 504, the expense types can be compared. Each travel event request can be labeled as being air, car, hotel, limousine, travel agent fee, etc. Many credit card charges can come with some expense type information. For others the expense type information can be deduced in 501 as previously discussed. As in previous steps, matches can be scored higher than mismatches.

In 505, vendor information can be compared. Travel event request and credit card charges often have vendor codes, typically two-character alphanumeric strings, that identify a vendor such as United or Hertz. If present then the vendor codes can be used. If not, then a string-based comparison of the vendor name can be made. One embodiment of string comparison involves finding the closest known vendor to the vendor name on both the credit card charge and the travel event request. Another embodiment would be to determine if the name on the credit card charge matches the travel event request, or if the first n characters for some integer n match.

In 506, expense-type-specific information can be compared. For example, with air tickets, the ticket numbers on the travel event request and the credit card charge can be compared. Other information can be used for other expense types if that information is available.

In 507, any other data that is present on both of the items being compared can be examined.

It should be noted that, in one embodiment, a user (e.g., a traveler) can submit a travel request, stored as travel data. This travel request can be made in multiple ways, including by using an on-line self-booking tool, by contacting a travel agent, or by contacting a travel vendor directly. The travel request can be stored, for example, as a Passenger Name Record (PNR) in a travel Global Distribution System (GDS) (e.g. Sabre, Amadeus, Worldspan, or Galileo). Those skilled in the art will understand that many data storage mechanisms can be used.

In one embodiment, travel data can include a number of travel event requests, where each travel event request includes, for example, a travel event type (e.g., air, rental car, hotel, limousine, train), a travel vendor (e.g., an airline), the location or locations of travel; travel dates, and information that is specific to the given vendor and travel event type (e.g., flight number, confirmation number, rental car class, number of beds in a hotel room). This travel data can often be included in travel data feeds. Expense data can be imported from credit card feeds. This expense data can be represented as a electronic text file that includes a list of expense transactions and corresponding detailed information, referred to as expense items. Those skilled in the art will understand that the exact format of this file may vary and that there are many other possible methods of transmission.

In one embodiment, the expense management application 110 can import this file and analyze it to identify the travelers/users who charged each of the transactions. Data can also be directly imported from the travel vendors themselves. The travel request data can also be imported from the GDS systems or other travel management systems.

In one embodiment, the traveler can pay for the travel event. The time of payment can vary from event to event on the same itinerary. For example, airline tickets can often be purchased in advance, whereas hotel fees are typically paid at checkout. The travel industry is evolving, and hotel and rental car vendors often request partial or complete payment in advance of travel. Acceptable methods of payment vary by vendor, although electronic payment by credit card is common. The credit card can be, for example, a personal credit card owned by the traveler or a corporate credit card. The corporate credit cards can be, for example, either issued to the traveler or centrally paid by the company (i.e., “ghost cards”). With centrally-billed cards, many travelers can use the same credit card to pay for multiple travel events. Those skilled in the art will recognize that there are other methods of payment that could be used.

FIGS. 6-7 illustrate various methods for determining whether an expense is an ancillary fee. In one embodiment, sometime after paying for the travel event, the traveler can be presented with an option to purchase ancillary goods or services. The option could be presented by an on-line self-booking tool, a travel agent, or the travel vendor itself at time of check-in or any time visiting the vendor's website or otherwise interacting with an agent of the vendor. The traveler can choose to purchase this option, and can pay typically with cash or a credit card but any method accepted by the travel vendor would suffice. Travel vendors can be continually evolving and enhancing the list of ancillary goods and services being offered, and this list of ancillary goods is not limited by the goods and services offered today (such as baggage fees, preferential boarding, or preferential seating).

In a further embodiment, a travel agency or an agent of the travel agency may charge the traveler for the service of making the reservation, or for another ancillary good or service provided by the agency.

After paying for one or more of the travel events and one or more of the ancillary goods or services, the traveler can submit an expense report. Expense reports can serve multiple purposes, including, but not limited to: allowing the employee to be reimbursed for approved out-of-pocket expenses incurred during business travel, allowing the company to track the consumption of travel event requests that were previously reserved in order to estimate, expenses that will be submitted in the future; or allowing the company to track travel event requests not reserved through the corporate travel management system; or any combination thereof. Companies often have contracts with specific travel vendors and/or agencies, and these contracts often have minimum purchase requirements that must be met in order for the company to receive the preferred rates specified in the contracts. Thus, it can be helpful to be able to track all amounts that are spent at a certain vendor.

Expenses incurred by the traveler while traveling at the request of his employer are generally reimbursed by the corporation. Companies have travelers complete expense reports that itemize the expenses, and have the expense reports approved by managers and/or employees in the accounting department. Systems that automate some or all of the expense reporting process can accept data feeds from corporate credit card vendors (e.g. Visa, American Express, MasterCard) and allow the travelers to import the credit card charges to reduce manual data entry and improve accuracy. Expense management systems can also be integrated with travel agency systems, or global distribution systems (GDS) (e.g., Apollo, Sabre, or Amadeus), to obtain, for example, travel itinerary data. The travel itinerary data can be matched with credit card data (using, for example, vendor information, amounts, dates of travel, etc.). Companies can then run reports on their travel and expense data to look at the total spent by type of transaction (e.g. air fare, rental car, meals, entertainment) or the total spent by supplier (e.g. United Airlines vs. American Airlines). More sophisticated systems can compare the amounts requested for reimbursement against the amount of a reservation to see if the actual cost differed from the initially requested cost, analyze the vendor spend for specific geographic regions or airline city pairs, and import receipts directly from vendors in order to have a third source for matching against the travel itinerary and credit card data.

Travel managers can use the reservation and expense data when negotiating with entities, such as airlines. For example, if a travel manager knows that her company is spending $1 million per year flying travelers from Washington, D.C. to Los Angeles, Calif., and that the amount is evenly split between two competing airlines, that travel manager could approach the airlines and offer to shift business from one to the other in exchange for some form of discount. Additionally, travel managers can set policies in systems that enable travelers to make travel reservations and systems that automate the completion of expense reports to indicate that certain expenses would not be reimbursed, or would need extra approval prior to reimbursement. For example, many companies do not reimburse for movies rented during hotel stays, or for airline club memberships (e.g. United Airlines Red Carpet Club) except under certain circumstances such as trips over a certain number of days or trips over a certain distance, or for certain very frequent travelers.

In the above situations, as well as in many other situations, ancillary fees can pose a challenge. For example, some ancillary fees can be charged at the time of the main purchase (e.g., at the time a ticket is purchased), while other ancillary fees are charged a check-in process or on-board. A traveler may not know at time of ticket purchase that a hag would be checked, or that the traveler would want a pillow on board. These ancillary fees can thus be charged to the traveler (e.g., via credit card) at a different time than the airline ticket itself. Thus, an entity would not always know what is being spent on these ancillary fees as opposed to, for example, the air fares themselves.

In one embodiment, a system and method are provided that can properly categorize ancillary fees as such, and can identify the specific reservation that corresponded to the main purchase (e.g., flight taken with airline ticket) on which the fee was incurred. In one embodiment, the system can enforce entity policies on these additional services. In one embodiment, reports can be provided that hold employees responsible for travel and accounting information about the spend, including the amount of spend by travel supplier and even the amount of spend in specific geographies, on certain routes, and/or by specific travelers or departments. This data can help the company negotiate these ancillary services as part of a contract with a specific travel vendor in lieu of or in addition to a specific rate on the base service. For example, a travel manager might prefer to negotiate free checked baggage instead of a 2% discount on the air fare, if it could be determined that the company was spending more than 2% of their air-related spend on checked baggage.

In one embodiment, the expense management application 110 can analyze the expenses submitted across one or multiple companies to identify changes in fees for ancillary goods or services, or identify new fees implemented by a travel vendor. The expense management application 110 could then adjust the criteria used to determine whether or not an expense corresponded to an ancillary fee based on the this data. In a further embodiment, the expense management application 110 could understand that a vendor may change the fee for a good or service effective a specific date and use the data to determine that effective date, and use that date information when analyzing incoming expenses.

In one embodiment, companies can configure travel policies that prevent the selection, require approval for the selection, or log selection of ancillary services procured at time of reservation that would incur ancillary fees. Travelers electing to purchase these services if they are against policy may be required to choose a reason from a list of possible reasons or provide an explanation of why they are violating the policy. Employees of the company would be able to run reports that identified the fees that were incurred in violation of policy and why the travelers indicated that policy had been violated. Sample policies relating to ancillary fees includes, but are not limited to determining: whether or not a given ancillary fee type is allowed as a business expense; whether or not a given ancillary fee type has exceeded a total amount spent (e.g., the traveler is allowed to spend $300 on airline lounges per year), or whether or not the expense report needs approval and if so by whom (e.g., the traveler needs approval by her boss and the travel manager to buy a seat upgrade).

In one embodiment, companies can configure policies as part of the expense reporting process, where the policies define whether or not certain types of fees would be reimbursed, if incurring certain amount of ancillary fees require an explanation or approval of the expense report, or if there is a cap on the maximum amount of certain types of fees that may be allowed. Practitioners of the art would understand that many other types of policies that could be configured. The expense reporting system could then enforce the policies, and employees of the company could run reports that analyzed the fees that were submitted for reimbursement and provided breakdowns of in-policy vs. out-of-policy fees.

Referring to FIG. 6, in 605, a user can begin an expense report. In 610, a user can import credit card charge or other information related to the expense.
In 615, an ancillary fee module 298 can determine if the expense is related to a particular category. The following methods, or any combination thereof, can be utilized to determine if the expense is related to a particular category. In one embodiment, this can be done by having the expense management application 110 maintain a database of vendors (e.g., airlines, car rental companies, hotels, etc.) and the ancillary goods and services offered by each. For example, if it is known that Delta charges $25 for a bag (categorized by the expenses management application 110 as a necessary air travel fee), and $20 for a preferred seat assignment (categorized by the expense management application 110 as an optional air travel fees), then a credit card charge from Delta for $25 on or near the day of travel can be categorized as “necessary air travel expenses” and a charge from Delta for $20 on or near the day of travel is likely to be categorized as “optional air travel expense”.

In another embodiment, determining what the ancillary fee was for can be done by having the expense management application 110 store and analyze the expenses submitted across one or multiple customers (e.g., entities) and/or across one or multiple travelers within the customers. This analyzing can be done to identify changes in fees for ancillary gods or services and/or to identify new fees implemented by a travel vendor. For example, data can be collected from all travelers within one customer whenever a traveler enters in information about an ancillary fee (e.g., $25 was for baggage for Delta, which was a “necessary air travel fee”). This data can then be searched when trying to determine in which category to place a $25 ancillary fee.

In another embodiment, the expense management application 110 can understand that a vendor may change a fee for a good or service effective on a specific date and use that date information when analyzing incoming expenses. The expense management application 110 can use this date information either when searching through the database of vendors and the ancillary goods and services offered by each and/or when searching through the database of submitted ancillary expenses.

It should also be noted that, in one embodiment, detailed receipt information from vendors (e.g., Delta, Airlines, Sabre global distribution system) and/or credit card companies (e.g., American Express) can be searched for certain search terms (e.g., bag, preferred seating, lounge, food, etc.). For example, the ancillary fee module 298 can determine whether an expense is related to air travel by searching for various words, codes, etc. in the credit card charge or other information related to the expense. For example vendor codes, merchant codes, airline codes or the word “air” or “airline” can be search for in a detailed credit card feed.

If it is determined that the expense is not related to a particular category of interest (e.g., air travel, car rental, hotel), in 620 the expense can be added to the expense report as an appropriate type. It should be noted that in some embodiments, nothing can be done with the data at this point as well.

If it is determined that the expense is related to a specific category, in 625, it is determined whether the expense is an ancillary fee. This can be done using several methods, or a combination of several methods. For example, it can be determined whether the amount of the expense is below a certain threshold (e.g., $75, $50), which could indicate that the expense was an ancillary charge. Additionally, information can be kept regarding other ancillary fees that other users have entered, and this information can be searched to determine if the fee is indeed ancillary. For example, if the same or another user had indicated that a fee for $25 for UNITED was an ancillary fee (e.g., for a bag), that information could be used to determine that a fee for $25 from UNITED is for an ancillary charge. In some embodiments, it can be suggested to the user that the charge is ancillary and also that it is for a bag.

In additional embodiments, the expense management application 110 can determine if an expense is an ancillary fee by maintaining a database of vendors (e.g., airlines, car rental companies, hotels, etc.), the ancillary goods and services offered by each, and the costs of said ancillary goods and services to help determine which expenses correspond to these ancillary goods and services. For example, if it is known that an airline charges $25.00 for a preferred seat assignment and $20.00 for a one-day pass to an lounge in the airport, then a credit card charge from that airline for $25.00 on or near the day of travel is more likely to represent a seat assignment chosen at check-in, a charge from that airline for $20.00 on or near the day of travel is likely to represent a seat assignment, and a charge for $45.00 may represent a single purchase that combined a seat assignment and a one-day pass to a lounge.

In a further embodiment, the expense management application 110 may contain a rules engine that can look at attributes of an expense including date, vendor name, merchant code, and amount and determine the likelihood that an expense corresponds to an ancillary fee. For example, an expense for a relatively small amount, or an amount below a pre-determined threshold, is more likely to correspond to a fee, so long as the vendor name matched an airline or the merchant code corresponded to an air merchant. An expense where the date of the expense corresponds to the date of a flight may be likely to correspond to a fee. An expense where the date of the expense is shortly after the date of a flight may be less likely to correspond to a fee, but still more likely than corresponding to an air fare. If an airline typically charges $99.00 or more for an air ticket, then a charge for less than or equal to $98.00 may be likely to correspond to a fee.

In 635, if the expense is determined to be an ancillary fee, it presents to the user that the expense is an ancillary fee, and in 635 the user can confirm this designation. In 640, the user can specify the type of ancillary fee (e.g., for a bag). In some embodiments, as indicated earlier, the ancillary fee module 298 can suggest to the user what the ancillary fee was for. In 645, the ancillary fee is added to the expense report.

In 645, in some embodiments, policies can be applied to the ancillary fee to determine whether the expense should be reimbursed. The automatic enforcement of travel policies can help companies control costs. Travelers/users who do not use these tools may not be subject to this policy enforcement, so companies have an interest in identifying these travelers. Expense management tools can include the capability of automatically paying credit card bills for company-issued credit cards. Travelers can be liable for expenses charged to these company-issued credit cards that are not approved by management. Thus, travelers often include expenses from company-issued credit cards on their expense reports to obtain the required approval and to automate payment. As payment for different travel events on the same travel request may occur at different times, it is entirely possible that multiple expense reports may be submitted for the same travel request.

In one embodiment, the company can establish policies for what ancillary goods or services would be approved corporate expenses, and enforce these policies at the time that the ancillary good or service is purchased. For example, if ancillary fees are tracked, once an ancillary fee is discovered, a search could be run to determine if the ancillary fee is against a policy for a particular traveler/user. In this way, an entity can stop employees, or certain employees, from buying better seats, pillows, lounge access, etc. In another embodiment the policies are additionally enforced, or only enforced, during the expense reporting process, as noted with respect to FIG. 6. In this way, an entity can make sure employees, or certain employees, are not reimbursed for better seats, pillows, lounge access, etc.

As noted in FIGS. 6 and 7 (discussed below), the expense management application 110 can receive the expense data and perform analysis to determine which expenses most likely correspond to airline fares and which most likely correspond to ancillary goods and services. The appropriate portions expense data and the analysis can be transmitted via computer network 105 to an expense management client, which can display the expense data and the results of the analysis to a user preparing an expense report. The user can choose whether or not to accept the results of the analysis, and then the expense data can be imported onto an “in-progress” expense report. The user can then submit an expense report with certain expense data coded as air fare and other data coded more generically as “ancillary fees,” specifically as being for a specific ancillary good or service, or a combination of the two.

FIG. 7 illustrates a method for discovering what an ancillary fee was for. As noted above, in some embodiments, the expense management application 110 can receive travel and expense data and perform analysis to determine which expenses likely correspond with which travel reservations. The results of this analysis can be transmitted via computer network 105, and the travel and expense data and the results of the analysis can be displayed to a user preparing an expense report. The user can choose whether or not to accept the results of the analysis, and then the matched travel and expense data can be imported onto an “in-progress” expense report. The expense management application 110 can further analyze the expense data to determine which expenses most likely correspond to ancillary goods and services. For example, it can be decided that a fee is an ancillary fee and not an airline ticket. The expense management application 110 can then analyze the expenses which correspond to ancillary goods and services and the expenses that correspond to airline fares to determine which air ticket contained the flights that were most likely to match to the flight for which the ancillary fee was incurred. For example, it can be determined that, for a London to DC air route, a traveler spent $1235 in average fare and an additional $47 in fees. This can be useful information for many reasons. For example, since many discounts are negotiated by city pair, a travel manager can go to preferred providers knowing that it would need to take a 4% discount off the air fare to make up for the new fees that are being charged.

The results of this analysis can be displayed to the user of the expense management application 110. The user can then submit an expense report with certain expense data coded as air fare and other data coded as an ancillary fee, with some or all of the ancillary fees additionally coded as matching flights corresponding to specific air tickets.

Referring to FIG. 7, in 705, a user can begin an expense report. In 710, a user can import trips and associated credit card charges. In 715, a system can match travel reservations to card charges. (This can be done, in some embodiments, using the methods described in FIGS. 3-51) In 720, the ancillary fee module 298 can examine card charges to find charges with a travel type that are not for purchases of a principal item (e.g., air ticket, hotel room, rental car, etc.). In 725, it is determined whether the fee is an ancillary fee. This can be done using the methods described in FIG. 6 in some embodiments. Those of ordinary skill in the art will see that other methods can also be used. If it is determined the fee isn't an ancillary fee, the user can be asked to enter in what the fee was for, or none or some other steps can be taken in 730.

If it is determined that the fee is ancillary, in 735, the ancillary fee module 298 can determine the most likely travel purchase to which the fee is associated. This can be done using several methods, or a combination of several methods. In one embodiment, this can be done by having the expense management application 110 maintain a database of vendors (e.g., airlines, car rental companies, hotels, etc.) and the ancillary goods and services offered by each. For example, if it is known that Delta charges $25 for a preferred seat assignment and $20 for a one-day pass to a lounge, then a credit card charge from Delta for $25 on or near the day of travel is more likely to represent a seat assignment chosen a check-in, a charge from Delta for $20 on or near the day of travel is likely to represent a seat assignment, and a charge for $45 may represent a single purchase that combined a seat assignment and a one-day pass.

In another embodiment, determining what the ancillary fee was for can be done by having the expense management application 110 store and analyze the expenses submitted across one or multiple customers (e.g., entities) and/or across one or multiple travelers within the customers. This analyzing can be done to identify changes in fees for ancillary gods or services and/or to identify new fees implemented by a travel vendor. For example, data can be collected from all travelers within one customer whenever a traveler enters in information about an ancillary fee (e.g., $25 was for baggage for Delta). This data can then be searched when trying to determine what a $25 ancillary fee was for.

In another embodiment, the expense management application 110 can understand that a vendor may change a fee for a good or service effective on a specific date and use that date information when analyzing incoming expenses. The expense management application 110 can use this date information either when searching through the database of vendors and the ancillary goods and services offered by each and/or when searching through the database of submitted ancillary expenses.

It should also be noted that, in one embodiment, detailed receipt information from vendors (e.g., Delta Airlines, Sabre global distribution system) and/or credit card companies (e.g., American Express) can be searched for certain search terms (e.g., bag, preferred seating, lounge, food, etc.). Some vendors and/or credit card companies can indicate that the fee was for a certain fee, or provide other information (e.g., date, airline name, machine-readable codes that represents an ancillary fee or type of ancillary fee, etc.) that allows the expense management application 110 to determine what an ancillary fee was for.

In 740, the user can confirm the fee association. In 745, the expense can be added to the expense report as an ancillary fee and linked to the correct trip.

It should be noted that, in some embodiments, the expense management application 110 can also receive receipts from vendors. The receipts may include the entire purchase including the original travel service plus the fees ancillary goods or services, or it may include only the ancillary goods or services. The receipt may take the form of a record transmitted directly from the travel vendor to the expense management application 110, an record transmitted from the travel agency, the global distribution system, or a travel reservation system to the expense management application 110, or a record transmitted from an airline ticket settlement system (such as the Billing Settlement Plan (BSP), or the systems operated by the Airlines Reporting Corporation (ARC)). These receipts may be matched to other expense data received or may be used as expense data themselves.

A practitioner of the art would recognize that while one embodiment may perform analysis and then transmit results to an expense management client, another embodiment could transmit the raw data to the expense management client and the client could perform the analysis, and a further embodiment could involve some portion of the analysis being done by the client and another portion done by another part of the expense management application 110.

In a further embodiment, the traveler/user can manually enter an expense item and then the system can analyze the manually imported expense item in conjunction with any imported travel and/or expense data to determine whether the manually entered item is likely to correspond to airfare or to ancillary fees.

In one embodiment, once the expense report is submitted, expense management steps can be performed, such as approving the report (although this could be skipped if for example, the expenses can be mapped to travel requests that have been approved prior to travel). The system can pay expenses, reimburse the traveler, and pay the credit card vendor. Expenses can also be exported to accounting systems. Reporting may also be performed showing total spend per travel vendor, total spend for ancillary fees, total spend for ancillary fees per vendor, or any of the above by geography or travel route. Additional reports may be performed based on the business needs of the user of the system.

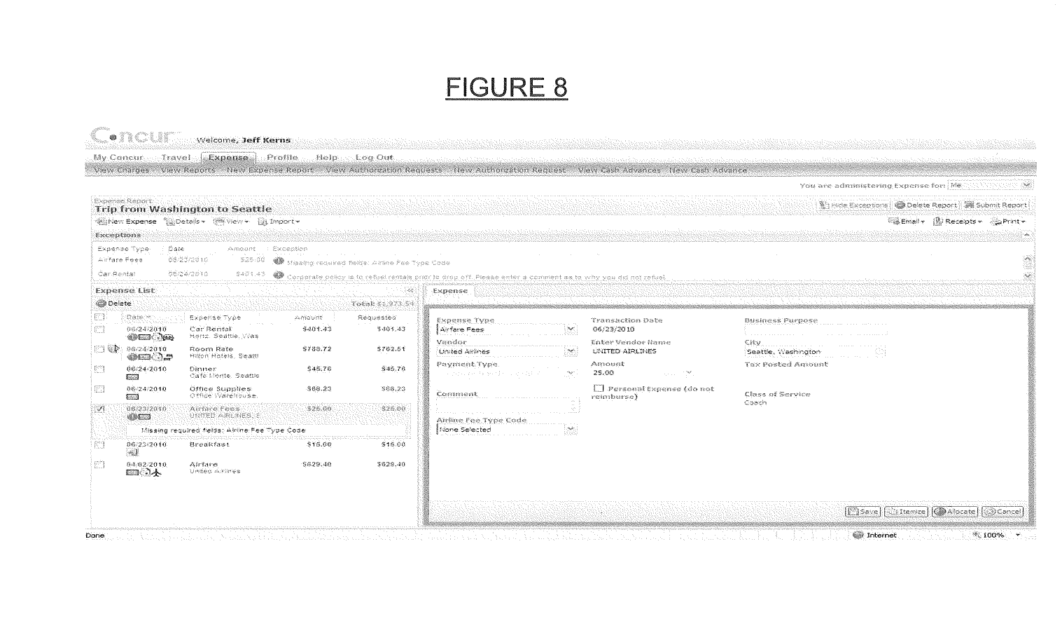

FIGS. 8-11 are screen shots illustrating various features utilized in some embodiments. FIG. 8 is a screenshot illustrating that a credit card charge has been recognized as an airfare fee (e.g., see “Expense Type” of “Airfare Fees” in the top left corner of the bottom right panel, and the application is asking the traveler to choose the type of Airline Fee. That is why there is a “Missing required fields: Airline Fee Type Code” in the Expense List for the highlighted expense, and there is an “Airline Fee Type Code” dropdown that is still saying “None Selected” in the bottom left corner of the bottom right panel.

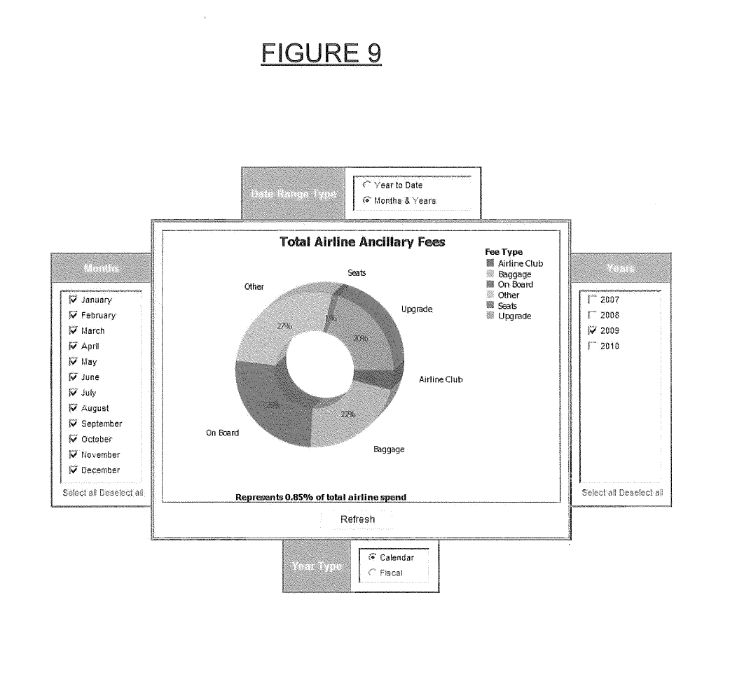

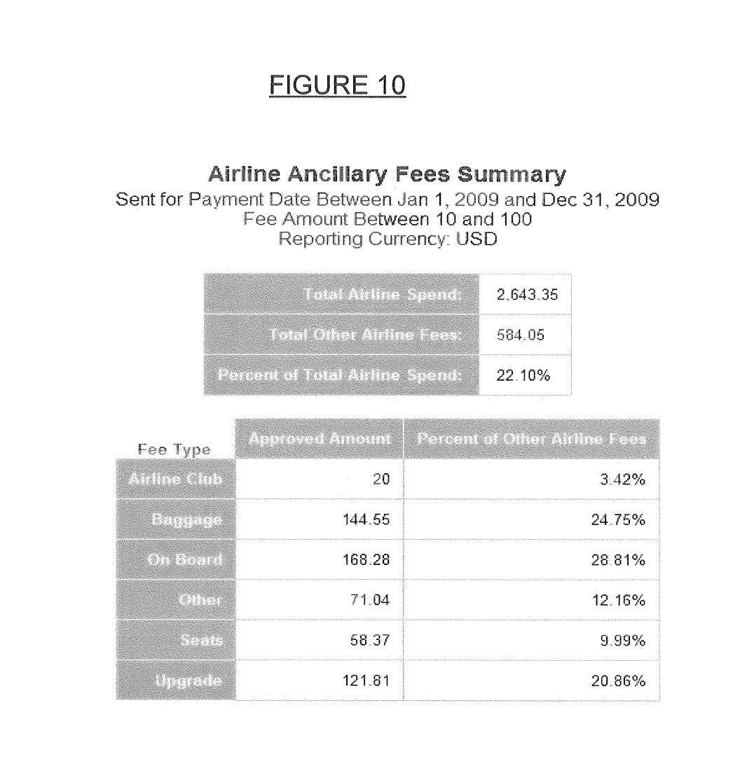

FIG. 9 is a screenshot that shows the ability to track (in this case a graphical report) the total spent on airline ancillary fees for a time period. FIG. 10 is a screenshot that shows the ability to track (in this case a tabular report) the total spent on airline ancillary fees for a time period, and compare that to total air spend. For the air travel example, some or all of the following information can be tracked: total air spend, air spend by carrier (e.g., showing air fare versus ancillary fees), air spend by city pair (e.g., showing air fare versus ancillary fees), total ancillary fee spend, or ancillary fee spend by carrier, ancillary fee spend by city pair, or any combination thereof. As noted above, it may be helpful for travel managers to know how much they are spending on fees and how much on airfares.

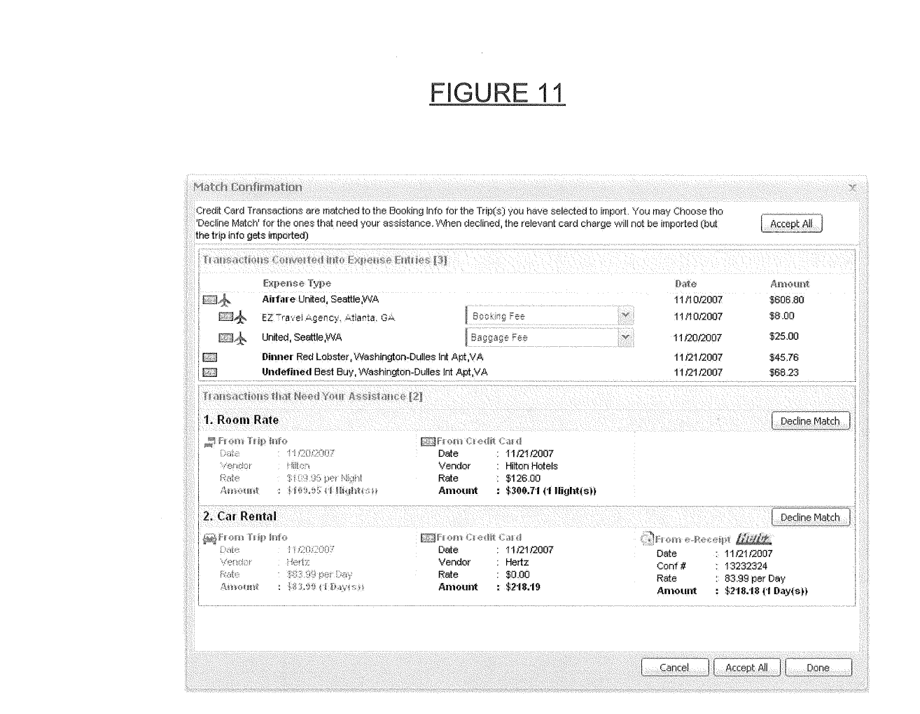

FIG. 11 is a screenshot which shows travel data being matched to the expense data to determine that there is airfare for United, and then the ancillary fee module 298 can determine that the $8.00 fee on the same day that the airline ticket was purchased is the travel agency booking fee for that ticket, and that the United Airlines fee for $25.00 that has a charge date equal to the date of travel on that airfare (note that this does not need to be explicitly shown) is an ancillary fee for that flight. This is then presented to the user and they can accept or decline this.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments

In addition, it should be understood that any figures which highlight the functionality and advantages, are presented for example purposes only. The disclosed methodology and system are each sufficiently flexible and configurable, such that it may be utilized in ways other than that shown. For example, the steps listed in any flowchart may be re-ordered or only optionally used (even when not explicitly indicated) in some embodiments. Thus, those skilled in the art will realize that the ordering of the steps in FIGS. 3-7 can be altered in other embodiments and that various steps can be removed in some embodiments.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A computer-implemented method of ancillary travel vendor fee expense management comprising:
receiving, by at least one expense management application, travel expense transaction data, said travel expense transaction data further comprising at least one expense transaction attribute;
generating, by the at least one expense management application, at least one travel expense transaction record, wherein said at least one travel expense transaction record includes said expense transaction data, and storing said at least one expense transaction record in an expense transaction database;
determining, by at least one ancillary fee, module which analyzes the at least one expense transaction attribute, whether the at least one expense transaction corresponds to a travel event, a fee for an ancillary good or service offered by a travel vendor, or a fee for an ancillary good or service offered by a travel agency;
presenting the at least one expense transaction record on a computerized user interface contained within at least one expense management application, wherein it is indicated whether the at least one expense transaction is at least one ancillary fee adding the at least one expense transaction record to an expense report.

2. The method of claim 1, wherein the travel expense transaction data comprises:
credit card data;
transaction data obtained directly from a travel vendor;
receipts obtained directly from a travel vendor;
data manually entered into an expense reporting application;
transaction data obtained from a travel agency;
or transaction data obtained from an airline transaction settlement organization;

3. The method of claim 1, wherein the travel expense transaction attribute comprises:
merchant information;
purchase date information;
date of travel information;
cost information;
a travel event type;
a description of an ancillary good or service purchased;
a code identifying an ancillary good or service purchased;
travel route, or other geographical information appropriate to the type of travel;
or any combination thereof.

4. The method of claim 3, wherein the travel event type comprises:
air travel;
rental transportation;
limousine service;
hotel;
train service;
a travel booking fee;
or any combination thereof.

5. The method of claim 3, wherein the ancillary good or service purchased comprises:
checking baggage;
seat assignment;
frequent traveler miles or points;
access to an airline club or lounge;
use of a pillow or blanket during a flight;
ability to store carry-on baggage in the overhead compartment in an airplane;
or food or beverage;
or any combination thereof.

6. The method of claim 3, wherein the merchant information comprises:
Merchant Category Code (MCC);
Standard Industrial Classification (SIC) code;
North American Industry Classification System (NAICS) code;
merchant name;
merchant address;
merchant telephone number;
merchant fax number;
merchant web site address;
an industry standard code identifying a type of merchant or a specific merchant;
or any combination thereof.

7. The method of claim 1 wherein the at least one ancillary fee module determines that the at least one expense transaction is more likely to correspond to an ancillary good or service if the purchase amount of the at least one expense transaction is at or below a pre-determined threshold.

8. The method of claim 1 further comprising: comparing, by the at least one ancillary fee module, the amount and the vendor of the at least one expense transaction record to a list of vendors, the ancillary goods and services offered by the vendors, and the fees known to be charged for each ancillary good and service, to better determine the likelihood that the at least one expense transaction corresponds to an ancillary good or service.

9. The method of claim 1 wherein an entity is able to track:
total amount spent for each type of ancillary good or service;
total amount spent with travel vendor for each type of ancillary good or service;
or any combination thereof;

10. The method of claim 1 further comprising:
receiving, by at least one server module, travel request data and/or travel reservation data corresponding to at least one travel event type, said request and/or reservation data further including travel request and/or reservation attributes comprising at least one of: a travel event time, a travel event type, an identifier for a travel vendor, a frequent traveler affinity program code, cost information for the at least one travel event, ticket number information for the at least one travel event, confirmation number information for the at least one travel event, an identifier representing the traveler, or any combination thereof;
generating, by the at least one server module, at least one travel request record, wherein at least one travel record includes said travel request and/or travel reservation information and storing said at least one travel request record in a travel request database;
determining, by at least one matching module, that at least one expense transaction record corresponds to the purchase of the travel event requested in the at least one travel request record;
transmitting to the at least one ancillary fee module the at least one travel request record and the at least one expense record that were determined to match as at least one combined travel and expense data record;
wherein the at least one ancillary fee module utilizes the at least one combined travel and expense data record to improve the determination as to whether at least one additional expense transaction corresponds to a travel event, a fee for an ancillary good or service offered by a travel vendor, or a fee for an ancillary good or service offered by a travel agency.

11. The method of claim 10 further comprising:
presenting the at least one combined travel and expense data record on a computerized user interface contained within at least one expense management application;
receiving, by the at least one expense management application, a user selection confirming that the at least one travel request record and the at least one expense transaction record matched by the at least one matching module do in fact correspond; and
adding the at least one combined travel and expense data record to an expense report as an expense item which comprises both the travel and expense data;

12. The method of claim 10, wherein the at least one ancillary fee module determines that the at least one additional expense transaction is more likely to correspond to an ancillary good or service if the purchase date of the at least one additional expense transaction matches or nearly matches the date of travel of the at least one combined travel and expense data record.

13. The method of claim 10, wherein the at least one ancillary fee module determines that the at least one additional expense transaction is more likely to correspond to an ancillary good or service if the one or more attributes of the at least one additional expense transaction matches or nearly matches at least one attribute of the purchase date of the at least one additional expense transaction matches or nearly matches the date of travel of the at least one combined travel and expense data record.

14. The method of claim 10 wherein an entity is able to track:
total amount spent by geographic region for each type of ancillary good or service;
total amount spent by origination and destination city for each type of ancillary good or service;
or any combination thereof;

15. The method of claim 1 wherein an entity is able to configure the expense reporting system to have policies that determine the maximum amount that an individual traveler may spend on a specific type of ancillary good or services, and wherein the expense reporting system may require approval for an expense report, or prevent submission of an expense report, if a user creates an expense report that would be in violation of these policies.

16. A computerized system for ancillary travel vendor fee expense management comprising:
at least one application configured to operate on at least one computer, the at least one application capable of:
receiving, by at least one expense management application, travel expense transaction data, said travel expense transaction data further comprising at least one expense transaction attribute;
generating, by the at least one expense management application, at least one travel expense transaction record, wherein said at least one travel expense transaction record includes said expense transaction data, and storing said at least one expense transaction record in an expense transaction database;
determining, by at least one ancillary fee module which analyzes the at least one expense transaction attribute, whether the at least one expense transaction corresponds to a travel event, a fee for an ancillary good or service offered by a travel vendor, or a fee for an ancillary good or service offered by a travel agency; wherein the at least one expense transaction indicates whether the at least one expense transaction is at least one ancillary fee;
adding the at least one expense transaction record to an expense report.

17. The system of claim 16 wherein the application is further configured for:
receiving, by at least one expense management application, travel request data and/or travel reservation data corresponding to at least one travel event type, said request and/or reservation data further including travel request and/or reservation attributes comprising at least one of: a travel event time, a travel event type, an identifier for a travel vendor, a frequent traveler affinity program code, cost information for the at least one travel event, ticket number information for the at least one travel event, confirmation number information for the at least one travel event, an identifier representing the traveler, or any combination thereof;
generating, by the at least one expense management application, at least one travel request record, wherein at least one travel record includes said travel request and/or travel reservation information and storing said at least one travel request record in a travel request database;
determining, by at least one matching module, that at least one expense transaction record corresponds to the purchase of the travel event requested in the at least one travel request record;
transmitting to the at least one ancillary fee module the at least one travel request record and the at least one expense record that were determined to match as at least one combined travel and expense data record;
wherein the at least one ancillary fee module utilizes the at least one combined travel and expense data record to improve the determination as to whether at least one additional expense transaction corresponds to a travel event, a fee for an ancillary good or service offered by a travel vendor, or a fee for an ancillary good or service offered by a travel agency.

18. The system of claim 17 wherein the application is further configured for:
presenting the at least one combined travel and expense data record on a computerized user interface contained within at least one expense management application;
receiving, by the at least one expense management application, a user selection confirming that the at least one travel request record and the at least one expense transaction record matched by the at least one matching module do in fact correspond; and
adding the at least one combined travel and expense data record to an expense report as an expense item which comprises both the travel and expense data.

19. The method of claim 1, wherein a list of possible types of ancillary goods and services, with a specific type of ancillary good or service pre-selected if the ancillary fee module determines the most likely type of ancillary good or service.

20. The system of claim 16, wherein a list of possible types of ancillary goods and services, with a specific type of ancillary good or service pre-selected if the ancillary fee module determine the most likely type of ancillary good or service.

21. The method of claim 7, wherein the pre-determined threshold may vary by travel vendor and/or dates of travel.

22. The method of claim 1, wherein the ancillary fee module analyzes the expense records on submitted expense reports corresponding to fees for ancillary goods or services to determine when vendors change the fees or add new fees for ancillary goods or services, and then adjusts internal rules based on this data to improve the determination of whether expenses correspond to fees for ancillary goods or services.

23. The method of claim 1, wherein after adding the at least one expense transaction to an expense report; at least one policy module determines whether any of the expenses on the expense report which correspond to fees for ancillary goods or services are in violation of company policies.

24. The method of claim 23, wherein the at least one client module presents any violations of company policies on a computerized user interface.

25. The method of claim 23, wherein any violations of company policies are transmitted to the at least one server module for storage along with the expense report in an expense reporting database.
